(19) United States
(12) Patent Application Publication
(10) Pub. No.: US 2004/0056444 A1
(43) Pub. Date: Mar. 25, 2004

(54) Steering system

(76) Inventor: Alan Leslie Bidwell, Yarraville (AU)

Correspondence Address: BAKER & BOTTS, 30 ROCKEFELLER PLAZA, NEW YORK, NY, 10112

(21) Appl. No.: 10/666,073

(22) Filed: Sep. 19, 2003

Related U.S. Application Data
(63) Continuation of application No. 09/869,878, filed on Sep. 7, 2001, now abandoned.

(30) Foreign Application Priority Data
Jan. 11, 1999 (AU) PP8067
Sep. 12, 1999 (WO) PCT/AU99/01095

(51) Int. Cl. B62D 1/00

(52) U.S. Cl. 280/99

(57) ABSTRACT

A compensating means (28) for compensating for different wheel turn angles in a vehicle, the vehicle having a plurality of wheels (12, 14, 16, 18) at least two of which (12, 14) are operatively connected by a drive system (22, 30) so as to turn simultaneously, the compensating means being adapted to be used with the drive system; the compensating means (28) including a first rotatable means (46) for rotation about a central shaft (44), a second rotatable means (48) for rotation about the central shaft (44), the first means (46) and the second rotatable means (48) being concentric, and a connecting means (52, 54) operatively connecting the first rotatable means (46) and the second rotatable means (48) for limited relative angular movement therebetween.

### FIELD OF THE INVENTION

The invention relates to an improved steering system for a hand-propelled vehicle and refers particularly, though not exclusively, to an improved all-wheel steering system for such vehicles.

### REFERENCE TO RELATED APPLICATION

The invention of this application is particularly useful with the invention disclosed in our earlier Australian patent application PP1990 filed Feb. 26 1998 (our“earlier Application”), the contents of which are hereby incorporated by reference. However, the present invention is not to be limited to use only with vehicles of the category described in our earlier application.

### DEFINITIONS

Throughout this specification reference to a vehicle is to be taken as including all hand-propelled or hand-drawn vehicles of the general category described in our earlier Application.

Furthermore, reference throughout the specification to a drive system is to be taken as including all forms of drive system in the general category as described in our earlier Application.

### BACKGROUND TO THE INVENTION

In our earlier Application there is described a system for providing multi-wheel steering, normally four-wheel steering, for smaller hand-propelled vehicles such as supermarket trolleys, work trolleys, and the like. In certain instances, there needs to be incorporated a form of compensation so that, for example, the angle of turn of the radially outer wheels will be different to that of the radially inner wheels. This is particularly important in a device such as a supermarket trolley which can turn corners very tightly to negotiate the aisles of a supermarket. Therefore, there needs to be a differentiating mechanism to allow this to happen without scrubbing the tyres of the wheels.

Furthermore, although the invention of our earlier Application will tend to stabilise wheel movement, over uneven terrain there could be shock transmitted from one wheel through the drive system. Therefore, by having a compensating mechanism, there will also be included the ability to compensate for limited, unwanted adverse movement of a particular wheel or wheels.

It is therefore the principal object of the prevent invention to provide a compensating means for a vehicle (as hereinbefore defined) so that the drive system (as hereinbefore defined) will allow for different radii of different wheels.

### BRIEF DESCRIPTION OF THE INVENTION

With the above and other objects in mind, the present invention provides a compensating means for compensating for different wheel turn angles in a vehicle (as hereinbefore defined), the vehicle having a plurality of wheels at least two of which are operatively connected by a drive system (as hereinbefore defined) so as to turn simultaneously, the compensating means being adapted to be used with the drive system; the compensating means including a first rotatable means for rotation about a central shaft; a second rotatable means for rotation about the central shaft, the first rotatable means and the second rotatable means being concentric, and a connecting means operatively connecting the first rotatable means and the second rotatable means for limited relative angular movement therebetween.

Preferably, the vehicle is a supermarket trolley. More preferably, it has four wheels, all of which are linked by the drive system. Advantageously, the drive system is in the form of a cable, belt, v-belt, chain, or the like.

The first rotatable means may be a cylindrical drum, as may be the second rotatable means. Preferably, the central shaft extends upwardly beyond the second rotatable means.

The connecting means may include a pin attached to the first rotatable means and extending upwardly through an elongate, arcuate slot in the second rotatable means. More preferably, the pin extends upwardly beyond the second rotatable means.

There may be provided a biasing system including two generally parallel and spaced apart arms pivotally attached to the second rotatable means at one side thereof and extending beyond the opposite side, there being provided a spring operatively connecting the two arms, the central shaft and the pin being located between and acting upon and being acted upon by the two arms.

It is preferred that the compensating means be mounted to the vehicle by means of an arm pivotally attached to the vehicle and to the compensating means, the arm having a spring between it and the vehicle.

### DESCRIPTION OF DRAWINGS

In order that the invention may be fully understood there shall be described a number of embodiments incorporating the principal features of the present invention, the description being with reference to the accompanying illustrative drawings in which:

FIG. 1 is a schematic top-plan view of the compensating means of the present invention;

FIG. 2 is a side view of the compensating means of FIG. 1;

FIG. 3 is a front view of the compensating means of FIGS. 1 and 2;

FIG. 4 is an enlarged top-plan view of the compensating means of FIGS. 1 to 3;

FIG. 5 is a front view corresponding to FIG. 4;

FIG. 6 is a view corresponding to FIG. 1 showing the respective angles when a left turn is being undertaken;

FIG. 7 is a view corresponding to FIG. 6 but without the angles indicated, and showing a sharp left turn;

FIG. 8 is a view corresponding to FIG. 7 but showing independent wheel movement;

FIG. 9 is, a top-plan view of a second embodiment of the present invention;

FIG. 10 is an end view of the embodiment of FIG. 9;

FIG. 11 shows the embodiment of FIGS. 9 and 10 in a left turn position; and

FIG. 12 is a view corresponding to FIG. 11 but in a right turn position.

### DESCRIPTION OF PREFERRED EMBODIMENTS

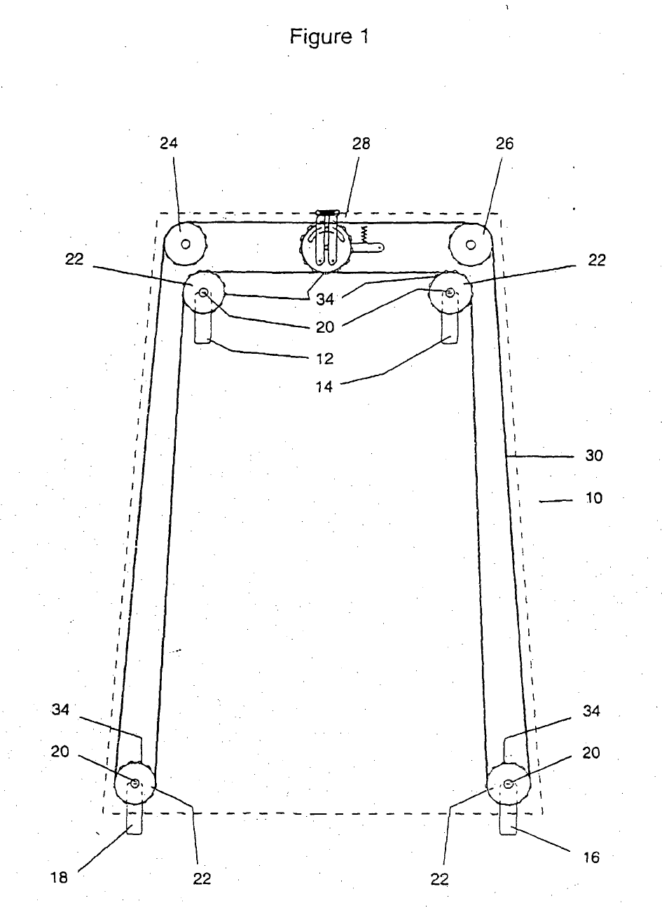

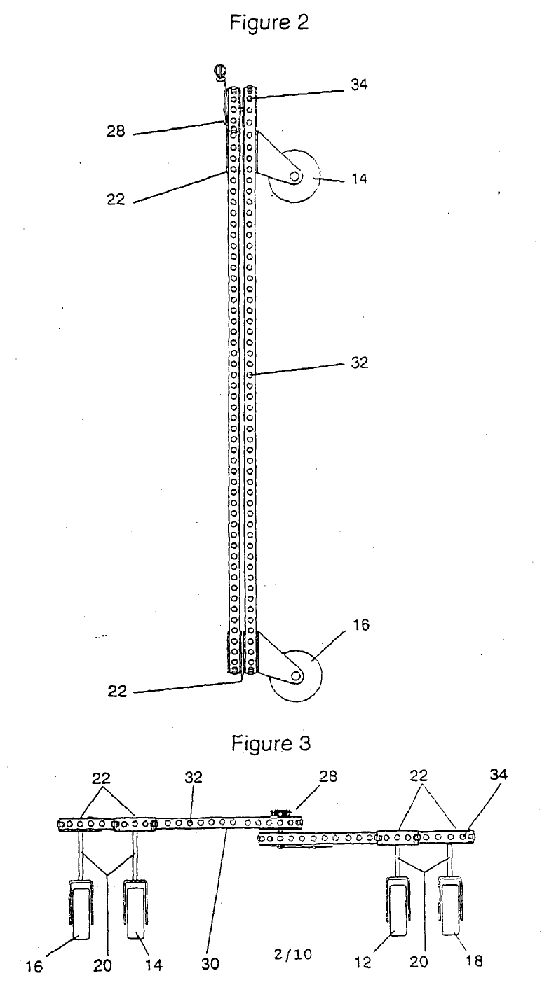

To refer firstly to FIGS. 1, 2 and 3 there is shown a vehicle generally designated as 10 and which in this instance is to represent a common device such as a supermarket trolley.

The vehicle 10 has four wheels 12, 14, 16 and 18 each mounted on a vertical swivel or castor axle 20 and which is concentric with and attached to a gear or drum 22. Two further idler gears 24, 26 are provided. A compensating means generally designated as 28 is also included. A continuous belt 30 passes around the gears 22, 24, 26 as well as the compensating means 28 (as will be described below) such that a four-wheel steering is created in accordance with our earlier Application.

The belt 30 is preferably a form of belt having a number of evenly-spaced openings 32 along its length, with the gears 22, 24, 26 having projections 34 to engage in openings 32 so that the belt 30 can drive gears 22, 24, 26, and via versa. In this way, rotation of any one wheel 12, 14, 16, 18 about its castor axle 20 will cause movement of the belt 30 by means of the gear 22 for that particular wheel, and this will cause the other gears 22, 24, 26 to also rotate to effect steering.

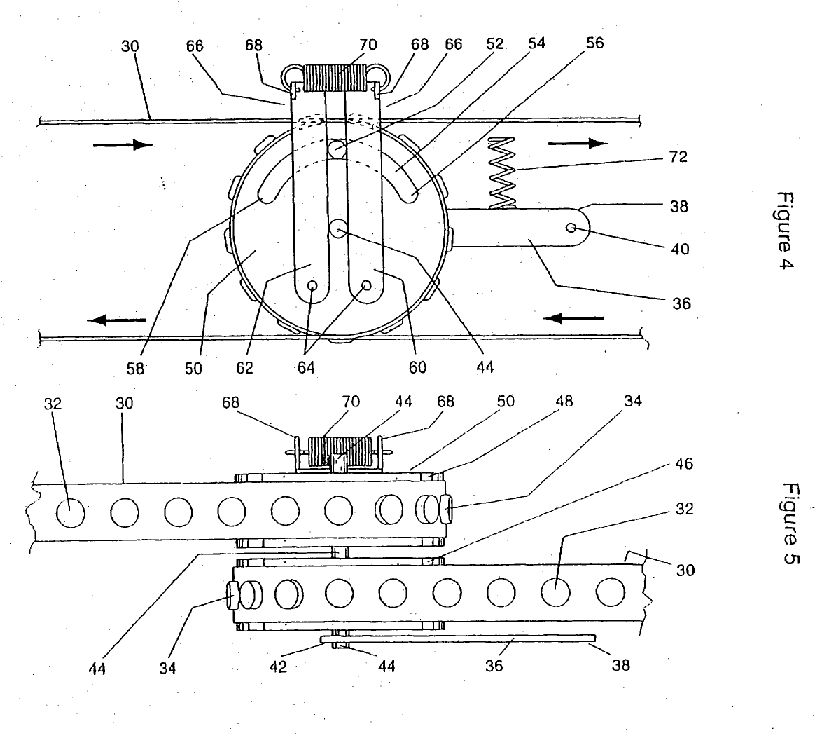

To now refer to FIGS. 4 and 5, there is shown in some detail the compensating means 28. Here, there is an arm 36 which at one end 38 is pivotally attached to the vehicle 10 by means of a pivot pin 40. At its other end 42 mounted on the arm 36 in a secure manner is a central shaft 44. Mounted on central shaft 44 for rotation relative thereto is a first rotating means 46 which, as shown, is a cylindrical drum of greater diameter than height. In this instance, the height of the first rotating means 46 is slightly greater than the height of the belt 30. The first rotating means 46 has a number of projections 34 which are adapted to engage at openings 32 on belt 30. Therefore, movement of belt 30 will cause a rotation of first rotating means 46, and vice versa.

Also mounted on central shaft 44 is a second rotating means 48 which is generally the same as first rotating means 46, although this need not always be the case. The shaft 44 extends upwardly above the upper surface 50 of second rotating means 48.

The second rotating means 48 also has a number of projections 34 which engage in openings 32 of belt 30. Therefore, similarly, movement of belt 30 will cause movement of second rotating means 48, and vice versa. It is to be noted from FIGS. 1 to 5 that the belt 30 passes around first rotating means 46 In the opposite way to that of second rotating means 48.

Securely attached to first rotating means 46 and extending upwardly therefrom is a pin 52. Pin 52 passes through an elongate, arcuate slot 54 in second rotating means 48. The slot 54 has a first end 56 and second end 58. The pin 52 projects upwardly beyond the upper surface 50 of second rotating means 48.

Mounted on upper surface 50 are two generally parallel arms 60, 62 pivotally attached thereto by pivot pins 64. The arm 60, 62 extend across the substantial portion of the upper surface 50 and beyond the circumference of second rotating means 48. At the outer ends 66 the two arms 60, 62 have an upwardly extending lug 68 to which is connected one end of a spring 70. Located between the arms 60, 62 is the upper end of central shaft 44 and pin 52.

It is preferred that the arm 36 is biased relative to the vehicle by means of a second spring 72.

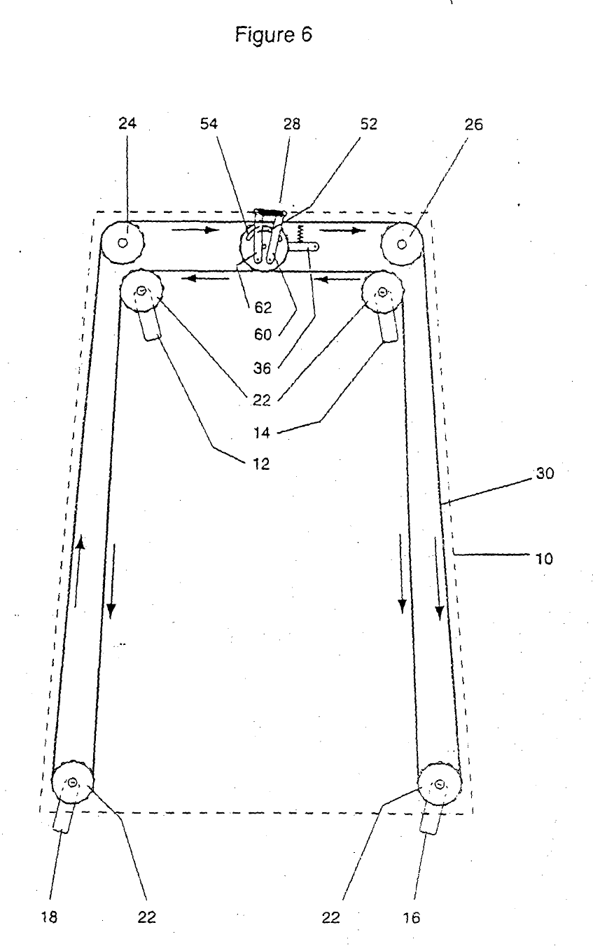

As can be seen from FIG. 6, if the vehicle 10 is moving along a curve, the radius of curvature for the wheels 12, 18 will be quite different to that of the wheels 14, 16. In this instance it is assumed that the radius of curvature for the wheel 12 is 1.53 metres—a fairly common radius in a supermarket situation. As can be seen, that radius of curvature would also pass through the castor axle 20 of wheel 18. However, the radius of curvature for wheel 14 is 2.12 metres, for a standard supermarket trolley. That means that the angle of turn required for wheel 14 will be different to the angle of turn required for wheel 12. Given the radii concerned, the angle required for wheel 12, compared to the longitudinal axis, is 16 degrees. For wheel 14, it is 11 degrees. A similar angle of 11 degrees is required for wheel 16, and again an angle of 16 degrees is required for wheel 18.

Therefore, when the vehicle 10 is turned to the position shown in FIG. 6, wheel 12 will turn to the left, as will wheel 14. Wheel 16, 18 turn to the right. Therefore, the belt moves as shown in the direction of the arrows.

To refer now to FIG. 4, where the arrows have been supplanted, as the belt 30 move to the leg as indicated, the first rotating means 46 will be moved by the belt 30 in a generally clockwise direction. Therefore, pin 52 will act upon arm 60 so that pin 52 will slide in slot 54 towards end 56. Arm 60 will pivot about the pin 64 and adopt the position as shown in FIG. 6. There will be resistance to arm 62 moving in a similar manner by virtue of arm 62 being pivoted around its pin 64 and acting on the upper end of central shaft 44. Therefore, the arm 62 will not tend to follow arm 60. However, by virtue of arm 60 being attached to second rotating means 48 it will cause some rotation of that second rotating means 48. Therefore, the belt 30 on the right side of the compensating means 28 will move, but by a lesser amount. This is because that part of the belt passes around the second compensating means 48. As such, the angle of the wheels 14, 16, will be less than for the wheels 12, 18 and thus the necessary compensation is created.

The degree of difference in the relative movement will vary according to the lengths of arm 60, 62 and in particular to the respective distances between pin 64 to central shaft 44, and central shaft 44 to the upper end 66 of the arm 60, 62. Also of significance is the tensile strength of spring 70.

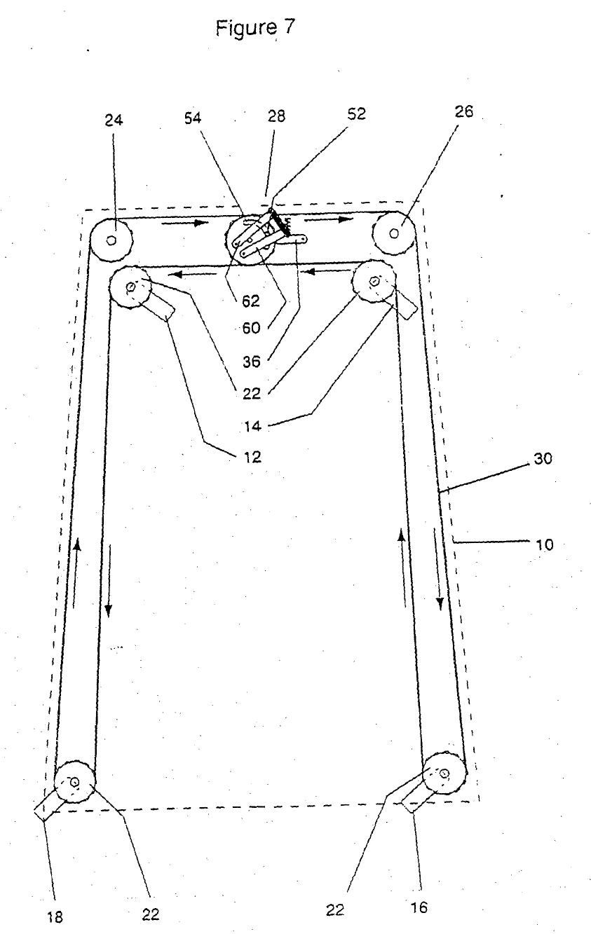

As is shown in FIG. 7 for a sharp left turn, the extent of movement means that the resistance of the spring 70 is substantially overcome, and thus the second rotating means 48 will rotate about central shaft 44 by almost as much as first rotating means 46. In this way the difference in angle between wheels 14, 16 as against wheels 12, 18 will be less as a percentage of the total angular movement. A difference of 5 degrees in 16 is a far greater percentage than a difference of 6 degrees in 45 degrees.

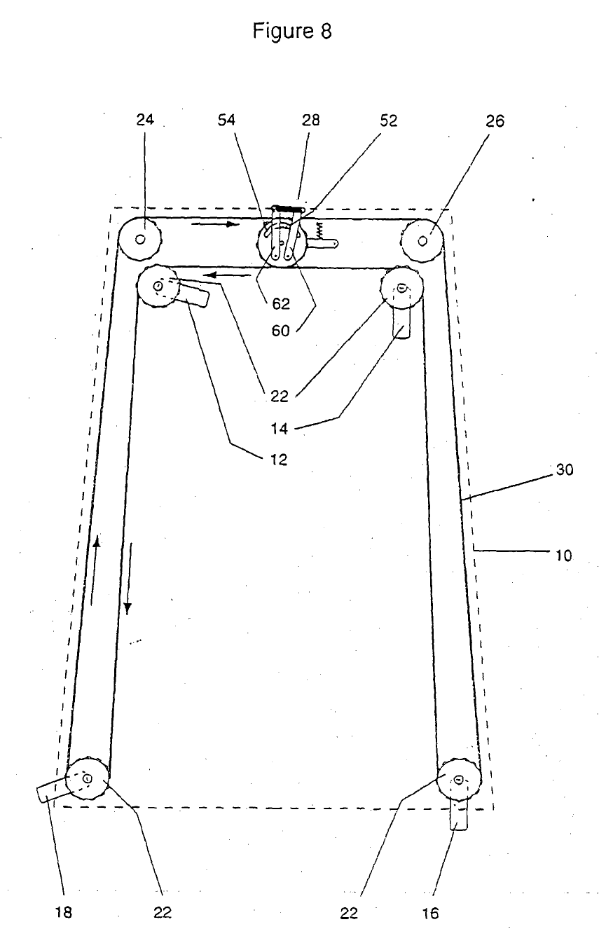

In FIG. 8 there is shown the difficulty than can occur when one wheel (in this instance wheel 12) is subjected to sudden, sharp movement such as by a pot hole, crack or the like. In this instance the resistance in spring 70 is substantially overcome such that the wheels 14, 16 remains substantially straight-ahead, yet wheels 12, 18 can move to the relevant position. Clearly, upon the pot hole, crack or the like being overcome, wheels 12, 18 will return to the straight-ahead position.

The effect of the spring 70 will also tends to bring both rotating means 46, 48 to the position as shown in FIGS. 1 to 3—the straight-ahead position. Therefore, upon a turn or curve being completed, a user does not have to return the vehicle 10 to the straight-ahead position, it will automatically assume that position.

Spring 72 assists in maintaining tension on the belt 30 at all times, and can also act as a shock-absorber in the event of sudden impact upon one or more of the wheels.

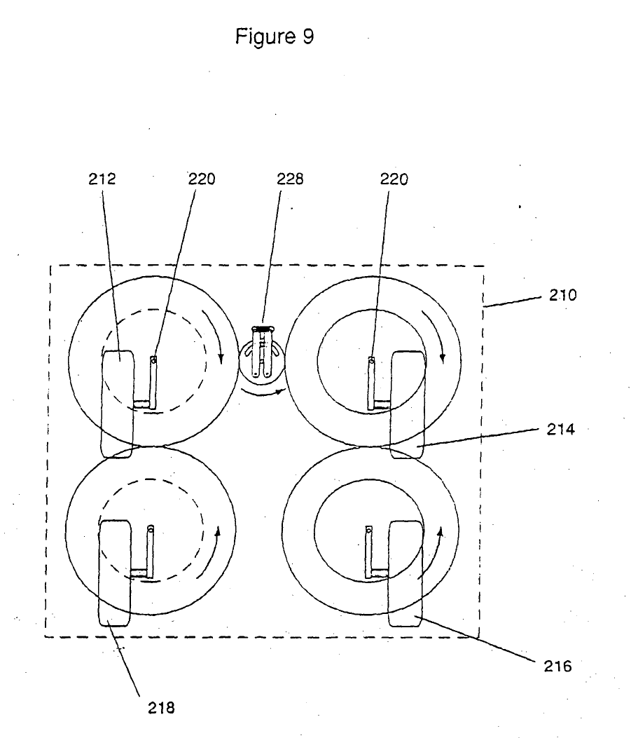

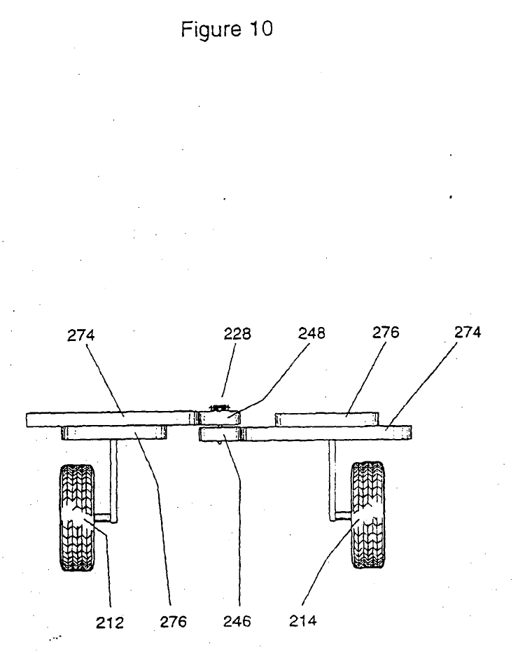

To now refer to FIGS. 9 through to 12, there is shown a second embodiment. In this second embodiment, like components have like reference numerals but with the addition of a prefix number 2.

Here, there is a vehicle 210 having four wheels 212, 214, 216 and 218. Each of the wheels is mounted to the vehicle 210 by a cast or axle 220. The wheels 212, 218 are arranged as a front and rear pair and the wheels 214, 216 are arranged as a front and rear pair. A compensating means 228 is placed between wheels 212, 214.

Each of the wheels 212, 214, 216, 218 has a larger diameter disc 274 and a smaller diameter disc 276. As can be seen, With the left pair of wheels 212, 218, the larger diameter discs 274 are above the smaller diameter discs 276, and contact each other. In this way, if wheel 212 moves to the right, wheel 218 turns to the left. A similar situation applies with the wheels 214, 216, except that their smaller diameter disc 276 is above the larger diameter disc 274, but the larger diameter discs 274 still contact each other such that the same reverse angle movement occurs.

With this arrangement, instead of belt 30 contacting the first and second rotating means, 46, 48 the larger diameter discs 274 contact the rotating means 246 and 248. In all other respects, the compensating means 228 operates the same as the compensating means 28.

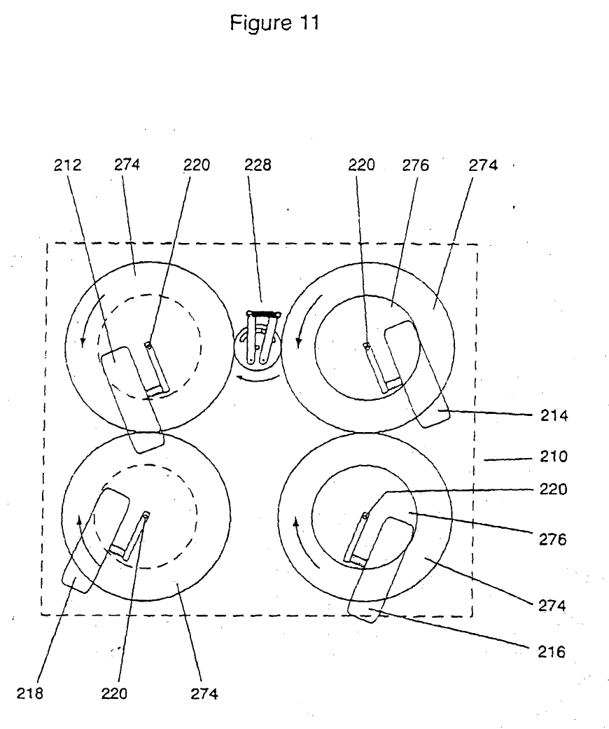

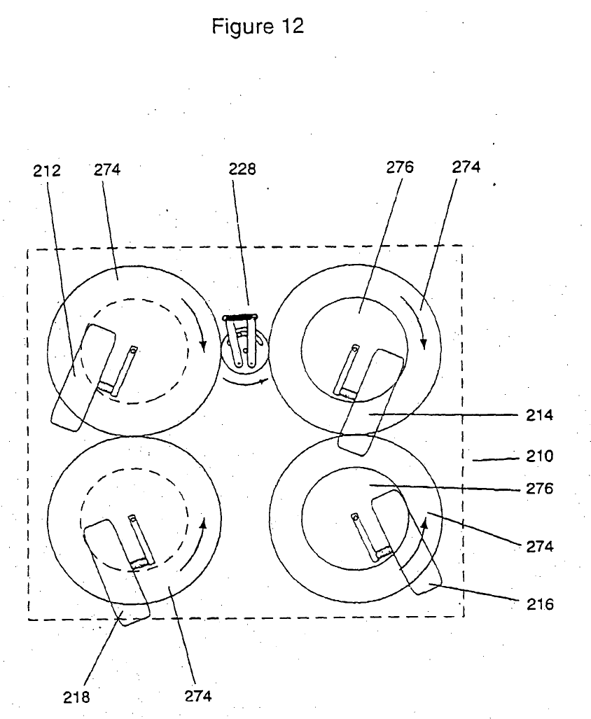

If one refers to FIGS. 11 and 12, it can be seen that for left turn and right turn, the wheels 212, 218 move at the same angle, and the wheels 214, 216 move at their angle (which may be an angle different to the wheels 212, 218) but the compensating means 228 will provide for the necessary change in angle.

Naturally, the invention is not limited to the drive arrangements as shown in the two embodiments, and any form of drive arrangement may be used, including a chain, or other suitable device. Furthermore, there may be less than the four wheels illustrated, with the invention also being suitable for three wheeled, or more than four wheel steering systems.

Whilst there has been described in the foregoing description preferred embodiments of an improved steering system for a hand-propelled vehicle it will be understood by those skilled in the technology concerned that many variations or modifications in details of design or construction may be made without departing from the scope of the present invention.

It will be understood that the invention disclosed and defined in this specification extends to all alternative combinations of two or more of the individual features mentioned or evident from the text or drawings. All of these different combinations constitute various alternative aspects of the invention.

It will also be understood that the term“comprises” (or its grammatical variants) as used in this specification is equivalent to the term “includes” and should not be taken as excluding the presence of other elements or features.

The claims defining the invention are as follows:

1. A compensating means for compensating for different wheel turn angles in a vehicle (as hereinbefore defined), the vehicle having a plurality of wheels at least two of which are operatively connected by a drive system (as hereinbefore defined) so as to turn simultaneously, the compensating means being adapted to be used with the drive system; the compensating means including a first rotatable means for rotation about a central shaft, a second rotatable means for rotation about the central shaft, the first rotatable means and the second rotatable means being concentric, and a connecting means operatively connecting the first rotatable means and the second rotatable means for limited relative angular movement therebetween.

2. A compensating means as claimed in claim 1, wherein the vehicle is a supermarket trolley.

3. A compensating system as claimed in claim 1 or claim 2, wherein the vehicle has four wheels, all of which are linked by the drive system.

4. A compensating system as claimed in claim 3, wherein the drive system is selected from the group consisting of a cable, belt, v-belt or chain.

5. A compensating system as claimed in any one of claims 1 to 4, wherein the first rotatable means is a cylindrical drum, as may be the second rotatable means.

6. A compensating system as claimed in any one of claims 1 to 5, wherein the central shaft extends upwardly beyond the second rotatable means.

7. A compensating means as claimed in any one of claims 1 to 6, wherein the connecting means includes a pin attached to the first rotatable means and extending upwardly through an elongate, arcuate slot in the second rotatable means.

8. A compensating means as claimed in claim 7, wherein the pin extends upwardly beyond the second rotatable means.

9. A compensating system as claimed in any one of claims 1 to 8, wherein there is included a biasing system including two generally parallel and spaced apart arms pivotally attached to the second rotatable means at one side thereof and extending beyond the opposite side, there being provided a spring operatively connecting the two arms, the central shaft and the pin being located between and acting upon and being acted upon by the two arms.

10. A compensating system as is claimed in claim 9, wherein the compensating means is mounted to the vehicle by means of an arm pivotally attached to the vehicle and to the compensating means, the arm having a spring between it and the vehicle.
